(19) United States
(12) Patent Application Publication
(10) Pub. No.: US 2017/0336956 A1
(43) Pub. Date: Nov. 23, 2017

(54) DISPLAY AND OPERATING DEVICE WITH A TOUCH-SENSITIVE DISPLAY FIELD, METHOD OF OPERATING THE DISPLAY FIELD AND COMPUTER PROGRAM PRODUCT

(71) Applicant: SIEMENS AKTIENGESELLSCHAFT, MUENCHEN (DE)

(72) Inventors: SIMON BUTSCHER, KONSTANZ (DE); JENS MUELLER, KONSTANZ (DE); TOBIAS SCHWARZ, MENGEN (DE)

(21) Appl. No.: 15/670,363

(22) Filed: Aug. 7, 2017

Related U.S. Application Data
(62) Division of application No. 14/353,079, filed on Apr. 21, 2014.

(30) Foreign Application Priority Data
Oct. 19, 2011 (DE) 10 2011 084 802.9

(51) Int. Cl. G06F 3/0484; G06F 3/0482; G06F 3/0483; G06F 3/0488

(52) U.S. Cl. CPC G06F 3/04847; G06F 3/0488; G06F 3/0482; G06F 3/0483

(57) ABSTRACT

A display and operating device has a touch-sensitive display field by way of which the parameters of a parameter vector can be changed. In order to set the parameters, a structure of circular or annular elements is displayed, on the circumference of which a corresponding contact element is positioned. Using the position of a contact element on the circumference of the ring element, the value of the parameter is coded. The contact element is moved by user interaction to different radial positions about the center of the respective ring element to change the parameter value along the display field in the radial direction, and rotated in the circumferential direction of the ring element. The resolution of the parameter adjustment can be established in a simple and intuitive manner by selecting the radial position of the contact element during its rotation.

### CROSS-REFERENCE TO RELATED APPLICATION

This application is a divisional of patent application No. 14/353,079, filed Apr. 21, 2014; which was a §371 national stage filing of international application No. PCT/EP2012/067845, filed Sep. 12, 2012, which designated the United States; this application also claims the priority, under 35 U.S.C. §119, of German patent application No. DE 10 2011 084 802.9, filed Oct. 19, 2011; the prior applications are herewith incorporated by reference in their entirety.

### BACKGROUND OF THE INVENTION

### Field of the Invention

The invention relates to a display and operating device having a display field which can be operated by a user by means of touch.

Touch-sensitive display fields in the form of touch displays or multi touch displays are used in a multiplicity of fields of application to reproduce and manipulate information. With such displays, different operating actions can be carried out by a user by touching said displays. One possible operating action is the changing of parameters by touching the display, for example using a keyboard displayed on the display or plus/minus arrows which can be used to vary the value of a parameter. It proves to be disadvantageous in this case that the adjustment of the value is often associated with a plurality of touch interactions by the user in the manner of typing, which can easily result in errors during input. Furthermore, the resolution or step size which is intended to be used to adjust a parameter value can be only inadequately changed by the user.

### SUMMARY OF THE INVENTION

The object of the invention is to provide a display and operating device which can be used to easily and intuitively display and change parameters.

This object is achieved by means of the display and operating device as claimed and a method for controlling a display and operating device as claimed. Developments of the invention are defined in the dependent claims.

The display and operating device according to the invention comprises a display field which can be operated by a user by means of touch and can be operated, in a computer-assisted manner, in particular via a microprocessor of the device, for a number of parameter vectors (that is to say groups of parameters) each comprising one or more parameters, in an adjustment mode in which the values of the parameter(s) from a range of parameter values associated with the respective parameter are visualized on the display field and can be adjusted by means of operation by the user.

According to the invention, visualization in the adjustment mode is effected in such a manner that a respective parameter vector is represented on the display field by a number of ring elements corresponding to the number of parameters of the respective parameter vector, a respective ring element being associated with a parameter and being reproduced as at least one part of a circle or ring. In one preferred variant, a ring element is represented in this case as a complete circle or ring with an angular extent of 360°.

The values of the parameter from the range of parameters for a respective ring element are coded according to the invention using positions along the circumference of the respective ring element, and the adjusted value of the parameter is displayed at the position corresponding to the value on the circumference using a touch element. In this case, the touch element is reproduced, in particular, as a circle which preferably has a diameter in the range of the extent of a human fingertip.

According to the invention, the touch element is configured in such a manner that it can be arranged at different radial positions around the center of the respective ring element using a user interaction and can be rotated by the user in the circumferential direction of the respective ring element around its center by means of touch, and in particular by means of touch using his finger or using a pen, and movement on the display field, the parameter being adjusted to the value of the position along the circumference of the respective ring element by rotating the touch element, which position results from the intersection of the respective ring element with a line running between the center of the respective ring element and the touch element. In one preferred variant, the line is permanently reproduced on the display field in this case when manipulating the touch element. If necessary, however, the line may also be only a virtual line which is not apparent on the display field.

The display and operating device according to the invention makes it possible to easily and intuitively change parameters by accordingly rotating a touch element associated with a ring element. Positioning the touch element in different radial positions makes it possible in this case for a user to easily and intuitively adjust the resolution or step size with which he would like to change the values of the corresponding parameter of the ring element. This is enabled by virtue of the fact that the values from the range of parameter values of the parameter are coded using the circumferential positions of the ring element. That is to say, the further radially to the outside the touch element is during rotation around the center, the finer the adjustment becomes since a larger distance must be covered in the circumferential direction in order to change the parameter value.

In the display and operating device according to the invention, the range of parameter values for the corresponding parameter is given by a predefined sequence of values. These values are preferably mapped to the circumference of the ring element associated with the parameter in accordance with this sequence (that is to say in the clockwise or anticlockwise direction). The range of parameter values may relate to any desired variables. In one particularly preferred embodiment, the range of parameter values for one or more parameters of at least one parameter vector is given by a numerical range of values. In one preferred embodiment, the touch element is configured in such a manner that, for positioning at different radial positions, it can be moved in the radial direction of the respective ring element by the user by means of touch, and in particular by means of touch using his finger or using a pen, and movement on the display field. Depending on the application, the touch element can be moved outward and/or inward in the radial direction of the ring element. The touch and movement of the touch element in order to change its radial position preferably form a joint user interaction together with the touch and movement in the circumferential direction of the ring element.

In one particularly preferred embodiment, at least one parameter vector comprises a numerical value consisting of an integer digit and a fractional digit, the integer digit and the fractional digit representing respective parameters of the parameter vector. According to the invention, these can therefore be adjusted in a suitable manner using separate ring elements, thus achieving fine adjustment of the corresponding numerical value.

In another particularly preferred embodiment, the extent of a respective ring element in the circumferential direction is used to code the entire range of parameter values for the parameter associated with the ring element. As a result, the range of parameter values is visually conveyed to the user in a simple manner using the extent of the ring elements.

In another refinement of the display and operating device according to the invention, at least one parameter vector comprises a plurality of parameters, the ring elements associated with the parameters being arranged concentrically around a common center. As a result, the adjustable parameters of a parameter vector are reproduced in a compact manner on the display field. In another refinement of the invention, the value of the parameter corresponding to the respective position is reproduced in textual form (that is to say on the basis of characters and, in particular, numerical digits) at one or more positions along a respective ring element, as a result of which the user is provided with clues as to how the values of the parameters change during rotation of the touch element. In another variant of the invention, the adjusted values of the parameters are also reproduced in textual form on the display field, with the result that the user is immediately provided with visual feedback on the value which has just been adjusted when manipulating the touch element.

In another embodiment of the display and operating device according to the invention, a value of a parameter which has been newly adjusted by the user can be confirmed by a user interaction. The confirmation is intended to result in the adjusted parameter being definitively adopted in the corresponding system represented on the display field. The user interaction for confirming the parameter preferably involves the user ending touch of the touch element, whereupon the touch element is automatically adjusted to the position corresponding to the newly adjusted value of the parameter on the circumference of the ring element. This can be visually conveyed, for example, by virtue of the actuating element automatically moving toward the ring element along the line between the center of the corresponding ring element and its current position.

In another preferred embodiment of the display and operating device according to the invention, the segment of the respective ring element between the starting value of the range of parameter values and the position corresponding to the adjusted value of the parameter on the circumference of the ring element is visually highlighted. The segment therefore represents a corresponding sector of a ring or circle. For example, this segment is represented in a different color than the remaining area of the ring element. As a result, the current value of the parameter for the corresponding ring element can be reproduced in the manner of a filling level.

In one preferred variant, the parameter(s) of a respective parameter vector comprise(s) control and/or regulating variables of a technical installation, the display and operating device interacting with the technical installation in such a manner that it transmits newly adjusted control and/or regulating variables to the technical installation, whereupon the technical installation can adopt the new settings for the control and/or regulating variables.

In another particularly preferred embodiment, the display field of the display and operating device can be operated in such a manner that a structure comprising a multiplicity of elements and, in particular, a technical installation is reproduced on the display field, a user being able to select the respective elements using a user interaction, whereupon a change is made into the adjustment mode for a number of parameter vectors associated with the selected element. In this mode, the parameters of the corresponding parameter vectors can then be visualized using ring elements, as described above, and touch elements can be adjusted.

The technical installation which is reproduced on the display field and the parameters of which are adjusted may relate to any desired fields of application. In one preferred variant, the structure is a technical installation, in which case the term “technical installation” should be broadly understood and may comprise a branched network of different technical components. In particular, the structure may relate to an energy supply and/or energy distribution installation, a telecommunication installation, a traffic monitoring installation, a power plant, an automation installation for process or production automation and/or a medical device.

In addition to the display and operating device described above, the invention also relates to a method for controlling a display and operating device in a computer-assisted manner, comprising a display field which can be operated by a user by means of touch and is operated, for a number of parameter vectors each comprising one or more parameters, in an adjustment mode in which the values of the parameter(s) from a range of parameter values associated with the respective parameter are visualized on the display field and can be adjusted by means of operation by the user. In this method, a respective parameter vector is represented on the display field by a number of ring elements corresponding to the number of parameters of the respective parameter vector, a respective ring element being associated with a parameter and being reproduced as at least one part of a circle or ring. The values of the parameter from the range of parameter values for a respective ring element are coded in this case using positions along the circumference of the respective ring element, the adjusted value of the parameter being displayed at the position corresponding to the value using a touch element.

In the method according to the invention, the touch element is animated on the display field in such a manner that it can be arranged at different radial positions around the center of the respective ring element using a user interaction and can be rotated in the circumferential direction of the respective ring element around its center by the user by means of touch and movement on the display field, the parameter being adjusted to the value of the position along the circumference of the respective ring element by rotating the touch element, which position results from the intersection of the respective ring element with a line running between the center of the respective ring element and the touch element. The method can therefore be used to control the display and operating device according to the invention. In particular, the method is configured in this case in such a manner that one or more of the preferred embodiments of the display and operating device according to the invention can also be controlled.

The invention also relates to a computer program product having program code which is stored on a machine-readable carrier and is intended to carry out the method according to the invention if the program code is executed on a computer. The invention also comprises a computer program for carrying out the method according to the invention if the program runs on a computer.

### BRIEF DESCRIPTION OF THE SEVERAL VIEWS OF THE DRAWING

Exemplary embodiments of the invention are described in detail below using the accompanying figures, in which:

FIG. 1 shows a schematic illustration of one embodiment of a display and operating device according to the invention in the form of a multi touch display;

FIGS. 2 to 4 show illustrations of the operation of the multi touch display in FIG. 1 for the purpose of adjusting parameters on the basis of annular elements according to one embodiment of the invention.

### DETAILED DESCRIPTION OF THE INVENTION

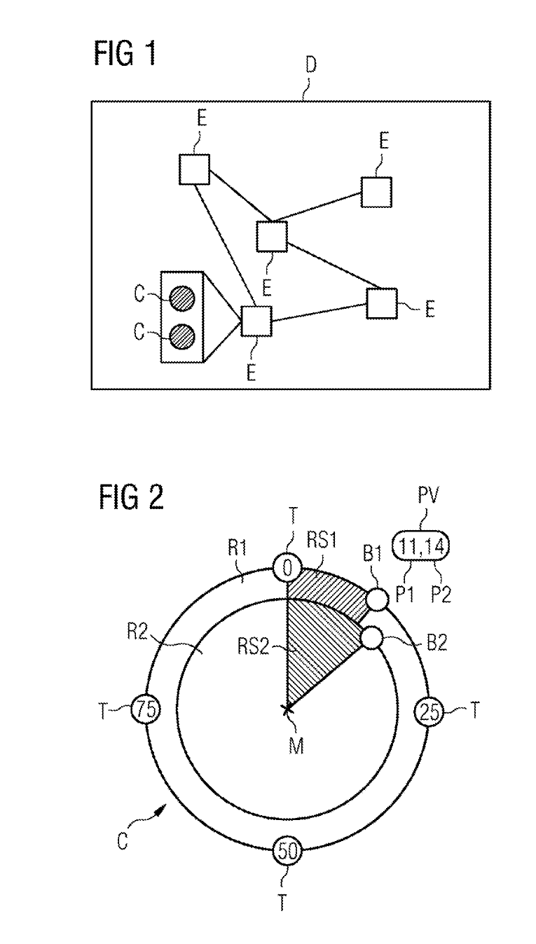

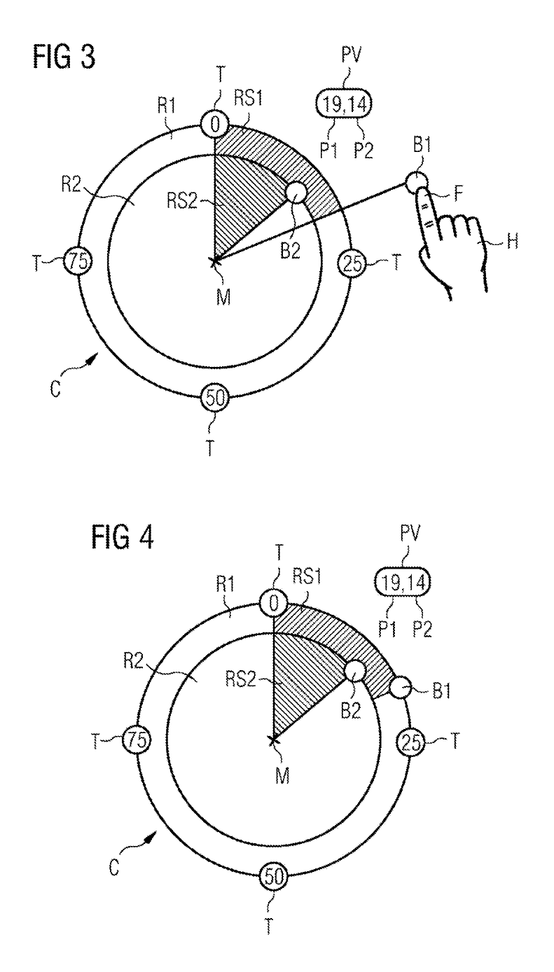

FIG. 1 shows a schematic illustration of a display and operating device according to the invention in the form of a multi touch display D, on the display field of which a network-like structure comprising a multiplicity of elements E (for example in the form of pictograms) is reproduced. Depending on the application, the network-like structure may relate to any desired systems or installations. In particular, it may be the illustration of an energy production and energy distribution installation, a telecommunication installation, a power plant, a process installation, a traffic monitoring installation and the like. The multi touch display is preferably an operating table which is installed in a control room for monitoring the corresponding system or the corresponding installation. In this case, the individual elements E are components of the corresponding network or the corresponding installation. A human operator can use the multi touch display to monitor the operation of the installation and to suitably change corresponding parameters of the individual elements E presented. In the embodiment in FIG. 1, this is achieved by virtue of the operator using his finger to tap a corresponding element E whose parameter he wishes to change, whereupon the circles C schematically illustrated in FIG. 1 are displayed to the operator. Each individual circle C is composed of annular elements which are described in more detail using FIGS. 2 to 4. The respective circle can be used to simply and intuitively change a process variable by touching the display. Technologies which are known per se can be used to implement the multitouch display D. For example, the display may comprise, on its underside, an optical system which is implemented by means of rear projection. In this case, the rear side of the display is illuminated using infrared emitters and touch on its top side is tracked on the basis of the change in the reflection behavior using an infrared camera behind the display. A further possible implementation of the display involves recognizing patterns on the basis of the so-called pixel sense technology in which infrared sensors sit in each individual pixel of the display and are used to detect touch on the surface by virtue of the change in the reflection behavior. If appropriate, it is also possible for the multi touch display to be implemented in a manner known per se by means of a capacitive touch surface, as is usually used in smart phones. One of the circles C illustrated in FIG. 1 for the correspondingly selected element is reproduced in an enlarged form in FIG. 2. If appropriate, it is also possible in this case for the user to have the circles displayed on an enlarged scale in a separate area of the display using a suitable interaction. A new image on the display can likewise be constructed with an enlarged illustration of the circle.

The changing of a process variable which is carried out using the circle on the basis of the adjustment of a numerical value between 0.0 and 99.99 is described below using FIGS. 2 to 4. However, the invention is not restricted to numerical values and it is also possible, if appropriate, to adjust process variables with other values using the circle C. According to FIG. 2, the circle C comprises an outer ring R1 and an inner circle R2, the outer ring R1 reproducing the integer digit P1 and the inner circle R2 reproducing the fractional digit P2 of a process variable PV. This process variable is a parameter vector in the sense of the claims. The value of the process variable PV is reproduced in textual form at the top right beside the circle C. In the scenario in FIG. 2, the integer digit P1 is adjusted to the value 11 and the fractional digit P2 is adjusted to the value 14. The ring and the circle are arranged concentrically around a common center M, and the corresponding range of values for the integer digit and the fractional digit of the process variable PV is coded by the total circumference of the ring or circle. That is to say, 360° of the outer ring R1 corresponds to the range of values for the integer digit between 0 and 99, whereas 360° of the inner circle corresponds to the range of values for the fractional digit between 0 and 99.

The current value of the integer digit and fractional digit is visualized using touch elements or anchor points B1 and B2 which are arranged on the outer edge of the ring R1 and of the circle R2. The corresponding value of the integer digit and ractional digit is indicated by the position of these touch elements with respect to the vertical line running through the center M. The value is also intuitively indicated by highlighting the ring segment or circle segment between the vertical line and the position of the corresponding touch element. The ring segment for the integer digit is denoted RS1 in FIG. 1 and the ring segment for the fractional digit is denoted RS2. In this case, the highlighting can be achieved by presenting the segment in a separate color which differs from the rest of the circle or ring. In order to illustrate the range of values in which the integer digit and the fractional digit can be moved, four text fields which are offset by 90° with respect to one another are also reproduced on the outer edge of the ring R1 and are denoted with reference symbol T. It is seen that an angular position of 0° corresponds to the numerical value 0, an angular position of 90° corresponds to the numerical value 25, an angular position of 180° corresponds to the numerical value 50 and an angular position of 270° corresponds to the numerical value 75.

The integer digit and fractional digit of the process variable PV are changed using the two touch elements B1 and B2 which constitute corresponding anchor points for the user's finger, as explained below. According to FIG. 3, a user would like to change the integer digit P1. For this purpose, the user uses the finger F of his hand H to grip the anchor point B1 which is originally on the edge of the outer ring R1. He can both pull this anchor point outward and push it inward and can also rotate it in the circumferential direction (that is to say tangentially) around the center M of the circle C. After the anchor point has been gripped, the line L is also continuously reproduced between the center M and the touch element B1. The value of the integer digit is increased or reduced by rotating the anchor point in the clockwise direction or in the anticlockwise direction around the center M. In this case, the current value of the integer digit is represented by the intersection of the line L with the outer ring R1, the size of the corresponding ring segment RS1 being changed at the same time. In the scenario in FIG. 3, the user used his finger F to first of all pull the touch element B1 outward and finally to rotate it through an angle, with the result that the integer digit P1 of the variable PV has changed from the value 11 to the value 19. The user can also change the fractional digit P2 of the process variable PV in the same manner by gripping and moving or rotating the anchor point B2. As clearly emerges from FIG. 3, the adjustment of the integer digit is finer, the further the user pulls the anchor point B1 outward since the corresponding values of the parameter are coded using the circumferential positions on the ring R1. That is to say, the further to the outside the touch element B1 is, the greater the distance to be covered by the finger F in the circumferential direction in order to accordingly change the value.

After the user has adjusted the integer digit to the desired value 19 in the scenario in FIG. 3, he can confirm this input in a simple manner by removing his finger from the touch element on the display field. Consequently, the process variable which has been newly adjusted is then adopted by the corresponding element of the system represented on the display. Releasing the anchor point also results in the touch element which has been released being reproduced on the edge of the corresponding ring or circle again, which is shown in FIG. 4. According to this illustration, in comparison with FIG. 3, the touch element B1 has been adjusted at the position of the integer digit with the numerical value 19 on the edge of the outer ring R1.

The embodiment of the invention described above has a number of advantages. The practice of coding corresponding values from a range of values to the circumferential position of a ring or circle and the practice of changing this position using a touch element make it possible for the corresponding parameter value to be simply and intuitively changed, the speed of the change being able to be suitably adjusted by the user by selecting the radial position of the touch element. The further the user pulls the anchor point outward, the more finely he can adjust the corresponding value, whereas the adjustment becomes coarser, the closer the anchor point is to the center. During manipulation of the touch element, the current value of the parameter is displayed to the user by means of a line L, with the result that the user is always provided with visual feedback on the value which has just been adjusted, which is also supported by highlighting the ring segment corresponding to the adjusted value.

1. A display and operating device, comprising:
a touch-sensitive display field to be operated by a user with computer-assistance for a number of parameter vectors each having one or more parameters, in an adjustment mode in which values of the parameter(s) from a range of parameter values associated with the respective parameter are visualized on the display field for adjustment by way of operation by the user;
a plurality of concentric ring elements displayed on said display field, said concentric ring elements sharing a common center and each of said ring elements representing a respective parameter vector on the display field, a number of said plurality of ring elements displayed on said display field corresponding to a number of parameters of the respective parameter vector, a respective ring element being associated with a parameter and being reproduced as at least one part of a circle or ring;
wherein the values of the parameter from the range of parameter values for a respective ring element are coded using positions along the circumference of the respective ring element, and the adjusted value of the parameter is displayed at the position corresponding to the value using a touch element;
said touch element being configured for placement at different radial positions around said center of the respective ring element by way of user interaction and for rotation by the user in the circumferential direction of the respective ring element around said center thereof by way of touch and movement on the display field, wherein upon rotation of the touch element, the parameter is adjusted to a value of the position along the circumference of the respective ring element, which position results from an intersection of the respective ring element with a line defined by a connection between said common center and said touch element, and wherein the parameter is more finely adjustable the farther the touch element is moved radially outward and the parameter is more coarsely adjustable the closer the touch element is moved towards the common center.

2. The display and operating device according to claim 1, wherein said touch element is configured in such a manner that, for positioning at different radial positions, it can be moved in the radial direction of the respective ring element by the user by means of touch and movement on the display field, this touch and movement preferably forming a joint user interaction with the touch and movement for rotating the touch element in the circumferential direction of the ring element.

3. The display and operating device according to claim 1, wherein the range of parameter values of one or more parameters of at least one parameter vector is given by a numerical range of values.

4. The display and operating device according to claim 1, wherein at least one parameter vector comprises a numerical value consisting of an integer digit and a fractional digit, the integer digit and the fractional digit representing respective parameters of the parameter vector which are reproduced on the display field using said ring elements.

5. The display and operating device according to claim 1, wherein an extent of a respective ring element in the circumferential direction is used to code an entire range of parameter values for the parameter associated with the respective said ring element.

6. The display and operating device according to claim 1, wherein at least one parameter vector comprising a plurality of parameters and said ring elements associated with the parameters are arranged concentrically around a common center.

7. The display and operating device according to claim 1, wherein the value of the parameter corresponding to the respective position is reproduced in textual form at one or more positions along a respective said ring element.

8. The display and operating device according to claim 7, wherein adjusted values of the parameter(s) are also reproduced in textual form on said display field.

9. The display and operating device according to claim 1, wherein a value of a parameter that has been newly adjusted by the user is enabled to be confirmed by a user interaction.

10. The display and operating device according to claim 9, wherein the user interaction involves the user ending touch of the touch element, whereupon the touch element is automatically moved to the position corresponding to the newly adjusted value of the parameter on the circumference of the ring element.

11. The display and operating device according to claim 1, wherein the line running between the center of the respective said ring element and said touch element is reproduced on said display field.

12. The display and operating device according to claim 1, wherein the segment of the respective said ring element between the starting value of the range of parameter values and the position corresponding to the adjusted value of the parameter on the circumference of the ring element is visually highlighted.

13. The display and operating device according to claim 1, wherein the display field is enabled to be operated in such a manner that a structure comprising a multiplicity of elements of a technical installation is reproduced on the display field, a user being able to select the respective elements using a user interaction, whereupon a change is made into the adjustment mode for a number of parameter vectors associated with the selected element.

14. The display and operating device according to claim 1, wherein the parameter(s) of a respective parameter vector comprise control and/or closed-loop control variables of a technical installation, the display and operating device interacts with the technical installation such that it transmits newly adjusted control and/or closed-loop control variables to the technical installation.

15. The display and operating device according to claim 14, wherein the technical installation is at least one installation selected from the group consisting of an energy supply installation, an energy distribution installation, a telecommunication installation, a traffic monitoring installation, a power plant, an automation installation, and a medical device.

16. A method for controlling a display and operating device with computer-assistance, the method comprising:
providing a display field to be operated by a user by means of touch, wherein the display field is operated, for a number of parameter vectors each comprising one parameter in an adjustment mode in which the values of the parameter(s) from a range of parameter values associated with the respective parameter are visualized on the display field and can be adjusted under user control;
representing a respective parameter vector on the display field by a plurality of ring elements, a number of the ring elements corresponding to the number of parameters of the respective parameter vector, a respective ring element being associated with a parameter and being reproduced as at least one part of a circle or ring;
coding the values of the parameter from the range of parameter values for a respective ring element using positions along a circumference of the respective ring element and displaying the adjusted value of the parameter at the position corresponding to the value using a touch element;
animating the touch element on the display field in such a manner that the touch element can be arranged at different radial positions around a center of the respective ring element using a user interaction and can be rotated in the circumferential direction of the respective ring element around its center by the user by way of touch and movement on the display field, the parameter being adjusted to the value of the position along the circumference of the respective ring element by rotating the touch element, which position results from the intersection of the respective ring element with a line extending radially from the center of the respective ring element and running through the touch element, and wherein the parameter is more finely adjustable the farther the touch element is moved radially outward away from the center and the parameter is more coarsely adjustable the closer the touch element is moved towards the center.

17. The method according to claim 16, wherein the providing step comprises providing the display and operating device with:
a touch-sensitive display field to be operated by a user with computer-assistance for a number of parameter vectors each having one or more parameters, in an adjustment mode in which values of the parameter(s) from a range of parameter values associated with the respective parameter are visualized on the display field for adjustment by way of operation by the user;
a plurality of concentric ring elements displayed on said display field, said concentric ring elements sharing a common center and each of said ring elements representing a respective parameter vector on the display field, a number of said plurality of ring elements displayed on said display field corresponding to a number of parameters of the respective parameter vector, a respective ring element being associated with a parameter and being reproduced as at least one part of a circle or ring;
wherein the values of the parameter from the range of parameter values for a respective ring element are coded using positions along the circumference of the respective ring element, and the adjusted value of the parameter is displayed at the position corresponding to the value using a touch element;
said touch element being configured for placement at different radial positions around the center of the respective ring element by way of user interaction and for rotation by the user in the circumferential direction of the respective ring element around the center thereof by way of touch and movement on the display field, wherein upon rotation of the touch element, the parameter is adjusted to a value of the position along the circumference of the respective ring element, which position results from an intersection of the respective ring element with a line running between the center of the respective ring element and the touch element.

18. A computer program product, comprising program code stored in non-transitory form on a machine-readable carrier and configured to execute the method according to claim 16 when the program code is executed on a computer.
